(19) United States
(12) Patent Application Publication
(10) Pub. No.: US 2020/0175456 A1
(43) Pub. Date: Jun. 4, 2020

(54) COGNITIVE FRAMEWORK FOR DYNAMIC EMPLOYEE/RESOURCE ALLOCATION IN A MANUFACTURING ENVIRONMENT

(71) Applicant: INTERNATIONAL BUSINESS MACHINES CORPORATION, Armonk, NY (US)

(72) Inventors: Nosaiba DAR MOUSA, Wappingers Falls, NY (US); Warren BOLDRIN, Montgomery, NY (US); John WALDRON, Highland, NY (US); Sreekanth RAMAKRISHNAN, San Jose, CA (US); Anthony TIANO, Kingston, NY (US)

(21) Appl. No.: 16/206,821

(22) Filed: Nov. 30, 2018

(51) Int. Cl. G06Q 10/06; G06Q 10/04

(52) U.S. Cl. CPC G06Q 10/063112; G06Q 10/0633; G06Q 10/04; G06Q 10/06398; G06Q 10/063118

(57) ABSTRACT

Disclosed is a computer-implemented method of employee/resource allocation across an enterprise. The method includes receiving, by a data processing system, a workload matrix, the workload matrix including job types and a level of demand for each job type; receiving, by the data processing system, an employee matrix, wherein the employee matrix comprises a plurality of employees and a plurality of characteristics associated with each of the plurality of employees; generating, by the data processing system, a skills matrix for the enterprise based on the plurality of characteristics associated with each of the plurality of employees; cognitively generating, by the data processing system, an optimization model; responsive to performing an iteration of the optimization model, assigning, by the data processing system, the plurality of employees to the plurality of job types based on the iteration, resulting in a report; and implementing the report in the enterprise.

### BACKGROUND

Often times a factory or supply chain operations mission within a production site is comprised of many diverse operations. Keys to efficiency exist with economies of scale and leveraging resources across these missions. This is especially true when examining the variation in ‘volume characteristics’ associated with each of these channels.

Within manufacturing environments, ordinarily, resources are assigned to channels. For each mission, customer demand is dynamically fluctuated with a fixed number of employee/resource allocations. Demand variability leads to variability in workload; high workload associated with peak demands and a smaller workload when demand is less. On the other side, inside the enterprise, there are some similar jobs. For instance, there might be two missions have some common tasks, one has low demand and underutilized employee/resource allocations and another mission has high demand and overloaded employee/resource allocations. In a centralized allocating schema, each channel assigns its available resources to its activities to optimize channel productivity. However, this doesn't guarantee optimizing employee/resource allocation efficiently at the factory level. Within any channel, when demand fluctuates, employee/resource allocation issues are raised. Resources could be either underutilized or management team faces the risk of losing orders and customers.

### SUMMARY

Shortcomings of the prior art are overcome and additional advantages are provided through the provision, in one aspect, of a computer-implemented method of employee/resource allocation across an enterprise. The method includes receiving, by a data processing system, a workload matrix, wherein the workload matrix comprises a plurality of job types and a level of demand for each job type; receiving, by the data processing system, an employee matrix, wherein the employee matrix comprises a plurality of employees; generating, by the data processing system, a skills matrix for the enterprise based on the plurality of characteristics associated with each of the plurality of employees; generating, by the data processing system, a performance matrix for the plurality of employees, the performance matrix comprising a plurality of characteristics associated with the plurality of employees and employee performance information; cognitively generating, by the data processing system, an optimization model from the workload matrix, the employee matrix, the skills matrix and the performance matrix; responsive to performing an iteration of the optimization model, assigning, by the data processing system, the plurality of employees to the plurality of job types based on the iteration, resulting in a report; and implementing the report in the enterprise.

In another aspect, a system for employee/resource allocation across an enterprise may be provided. The system may include, for example, memory(ies), at least one processor in communication with the memory(ies). The memory(ies) include program instructions executable by the one or more processor to perform a method. The method may include, for example, receiving, by a data processing system, a workload matrix, wherein the workload matrix comprises a plurality of job types and a level of demand for each job type; receiving, by the data processing system, an employee matrix, wherein the employee matrix comprises a plurality of employees; generating, by the data processing system, a skills matrix for the enterprise based on the plurality of characteristics associated with each of the plurality of employees; generating, by the data processing system, a performance matrix for the plurality of employees, the performance matrix comprising a plurality of characteristics associated with the plurality of employees and employee performance information; cognitively generating, by the data processing system, an optimization model from the workload matrix, the employee matrix, the skills matrix and the performance matrix; responsive to performing an iteration of the optimization model, assigning, by the data processing system, the plurality of employees to the plurality of job types based on the iteration, resulting in a report; and implementing the report in the enterprise.

In a further aspect, a computer program product may be provided. The computer program product may include a storage medium readable by a processor and storing instructions for performing a method. The method may include, for example, receiving, by a data processing system, a workload matrix, wherein the workload matrix comprises a plurality of job types and a level of demand for each job type; receiving, by the data processing system, an employee matrix, wherein the employee matrix comprises a plurality of employees; generating, by the data processing system, a skills matrix for the enterprise based on the plurality of characteristics associated with each of the plurality of employees; generating, by the data processing system, a performance matrix for the plurality of employees, the performance matrix comprising a plurality of characteristics associated with the plurality of employees and employee performance information; cognitively generating, by the data processing system, an optimization model from the workload matrix, the employee matrix, the skills matrix and the performance matrix; responsive to performing an iteration of the optimization model, assigning, by the data processing system, the plurality of employees to the plurality of job types based on the iteration, resulting in a report; and implementing the report in the enterprise.

Further, services relating to one or more aspects are also described and may be claimed herein.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a modified high-level flow diagram of one example of a computer-implemented method of employee/resource allocation across an enterprise, in accordance with one or more aspects of the present disclosure.

FIG. 2 is a combination flow/block diagram of another example of a computer-implemented method of employee/resource allocation across an enterprise, in accordance with one or more aspects of the present disclosure.

FIG. 3 is a flow diagram for one example of a computer-implemented method of employee/resource allocation across an enterprise, in accordance with one or more aspects of the present disclosure.

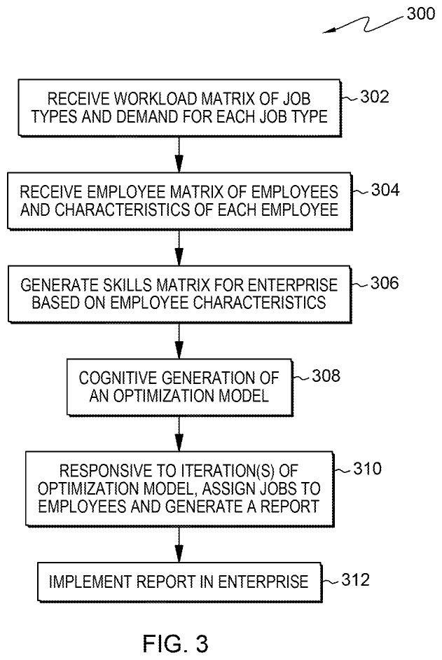

FIG. 4 is a block diagram of one example of a computer system, in accordance with one or more aspects of the present disclosure.

FIG. 5 is a block diagram of one example of a cloud computing environment, in accordance with one or more aspects of the present disclosure.

FIG. 6 is a block diagram of one example of functional abstraction layers of the cloud computing environment of FIG. 5, in accordance with one or more aspects of the present disclosure.

FIG. 7 is a hybrid flow diagram of one example of an overview of the basic steps for creating and using a natural language classifier service, in accordance with one or more aspects of the present disclosure.

FIG. 8 is a flow diagram for one example of employee/resource allocation in a manufacturing environment, in accordance with one or more aspects of the present disclosure.

FIG. 9 is a block diagram of one example of a system for employee/resource allocation across an enterprise in a manufacturing environment, in accordance with one or more aspects of the present disclosure.

### DETAILED DESCRIPTION

One or more aspects of this disclosure relate, in general, to employee/resource allocation. More particularly, one or more aspects of the present disclosure relate to dynamic employee/resource allocation in a manufacturing environment.

Above and beyond cross training and temporary assignments, the management and leadership team needs to be able to assign resources in a variable and dynamic manner to respond to the day to day attributes associated with volume and priorities. Furthermore, there will probably be two additional components: 1) manpower for lower skilled operations and ease to reassign is possible, and 2) jobs where there is a higher degree of training and possibly less flexibility exists, coupled with a variable emotional component of employee, such as receptiveness to move and/or conversely lack of desire to move. While standard work practices can be used to optimize resources within and across the factory, more real-time and multi-factors could be utilized to make more effective day-to-day coverage plans. This invention presents a dynamic approach to assign available resources to several activities in a way that increases their efficiency and achieve production plan. The developed solution considers the diversity of operations within factory's channels, required skills, variations in volume of the workload for each operation and employee's skills, experiences and training.

As used herein, the term “enterprise” refers to a business or company having one or more production (or manufacturing) line employing people on the line(s).

As used herein, the term “employee matrix,” refers to a matrix of employees and job types with a proficiency level on a predetermined scale of proficiencies for each employee at each job type. “Workload matrix” refers to a matrix of job types and customer demand. A “performance matrix” refers to a matrix of employees and actual or estimated performance for all job types.

As used herein, the term “optimization model” refers to a type of mathematical model that attempts to optimize (maximize or minimize) an objective function without violating resource constraints; also known as mathematical programming. Optimization models include Linear Programming (LP), integer programming and zero-one programming.

As used herein, the term “employee” or “employees” refers to people working or who will be working on one or more production line in an enterprise. The term includes formal employees, as well as contract workers, those coming from a temporary worker firm, etc.

Approximating language that may be used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” or “over” the other elements or features. Thus, the example term “below” may encompass both an orientation of above and below. The device may be otherwise oriented (e.g., rotated 90 degrees or at other orientations) and the spatially relative descriptors used herein should be interpreted accordingly. When the phrase “at least one of” is applied to a list, it is being applied to the entire list, and not to the individual members of the list.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage medium(s) having computer readable program code embodied thereon.

The present invention may be a system, a method, and/or a computer program product at any possible technical detail level of integration. The computer program product may include a computer readable storage medium (or media) having computer readable program instructions thereon for causing a processor to carry out aspects of the present invention.

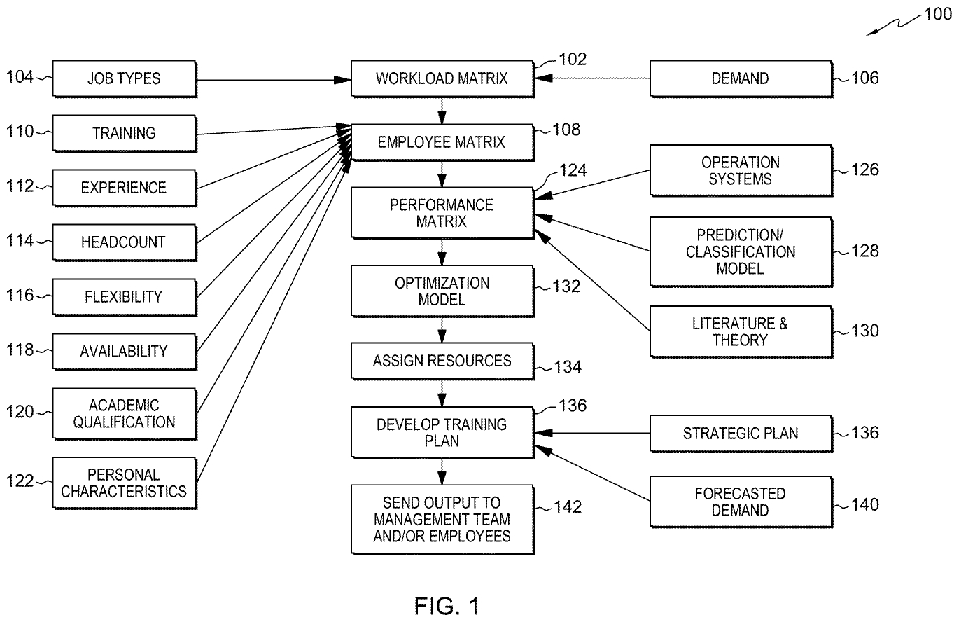

FIG. 1 is a modified high-level flow diagram 100 of one example of a computer-implemented method of employee/resource allocation across an enterprise, in accordance with one or more aspects of the present disclosure. A workload matrix 102 has inputs of, for example, “job types” 104 and demand 106, demand referring to customer demand, the customer being, for example, that of a provider of dynamic employee/resource allocation services. The term “job types” refers to the various types of jobs necessary for a given production line. For example, there may be a range of unskilled, skilled and highly trained types of jobs on a given production line. There is also an employee matrix 108, which includes employees and characteristics of each employee. The input to the employee matrix includes, for example, for each employee included in the matrix, an indication of a level of training 110, an indication of experience 112, a head count 114 (i.e., a number of employees included in the matrix), an indication of how flexible 116 the employee is with regard to, for example, what job types the employee is willing to work or if the employee would be willing to move, an indication of an availability of the employee 118 (i.e., which days and possible hours on a given day the employee is available), any academic qualifications 120 (e.g., certificates, degrees), and personal characteristics 122 of the employee (e.g., aptitude, performance, teamwork, specials needs accommodations, etc.). Other variables could also or instead be used. A performance matrix 124 includes inputs such as, for example, operation systems 126 to identify a performance of each employee, a prediction/classification model 128, which provides a prediction of performance doing a job when performance from operation systems is not available. Assume that employee 1 and employee 2 have the same characteristics, from system we know how long does it take employee 1, however, we do not have that measure for employee 2, so we use similarity. To find similarity we use clustering, and any literature or theory 130 to be used in identifying candidates for jobs needed to identify work that has to be done to meet customer demand. For example, product A requires test, assembly and packaging, product B requires assembly, test, and packaging. An estimated execution time is determined. For example, assume there are three employees and we need to know how long it will take employee 1 to do job 1, job 2, etc., and same for the rest of employees. From the Performance Matrix, an optimization model 132 is developed by the data processing system, as described subsequently in more detail. The optimization model is run based on the three matrices (workload, employee and performance), the output of which is an assignment 134 of the available employees to the job types required. An employee training plan 136 can be developed with input of, for example, and forecasted demand 140. The job assignments may be sent 142 to management and/or employees digitally, for example, via a Web application.

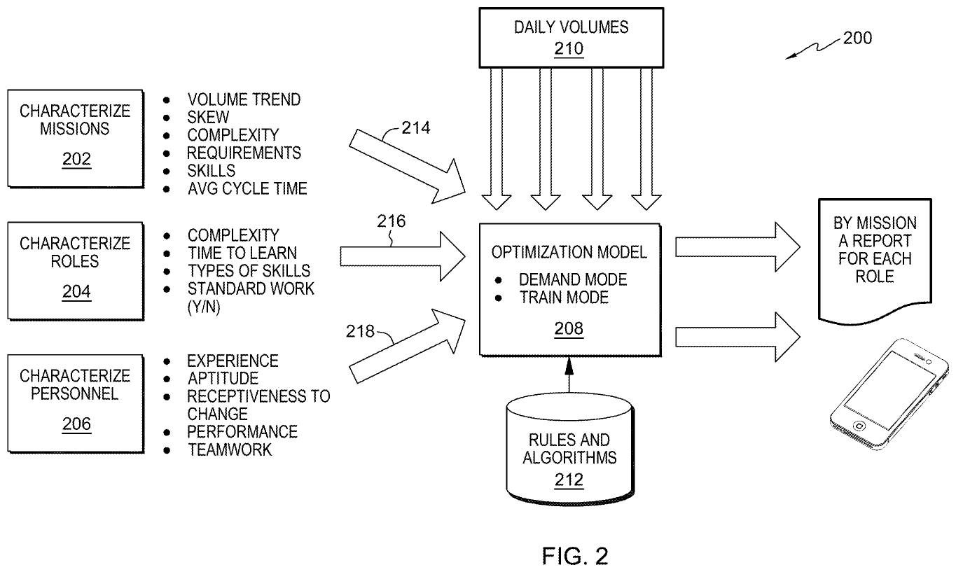

FIG. 2 is a combination flow/block diagram 200 of another example of a computer-implemented method of employee/resource allocation across an enterprise, in accordance with one or more aspects of the present disclosure. As shown in FIG. 2, missions of the enterprise are characterized 202. As used herein, the term “mission” refers to two or more jobs of the enterprise (e.g., building servers for a client, refurbishing a computer peripheral for a client or another division of the enterprise, or other contract work). Characterizing missions of the enterprise may include one or more of, for example, volume trend, skew of volume versus time, an indicator of complexity of the mission (e.g., a scale), resource requirements, skill requirements and average cycle time (i.e., how long a mission will take to perform). Related to the skill requirements, the roles 204 of a mission may be outlined. Information regarding the mission roles may include one or more of, for example, an indication of a complexity of the role (e.g., a level of complexity), a time to learn the role for an employee, the types of skills required for a given role and whether the work is standard or not (e.g., standard may include low or no skills). Personnel may also be characterized 206. Characteristics of a given employee may include, for example, a level of experience, aptitude, receptiveness to change (e.g., job and/or location change), historical and/or predicted performance and an indication of a degree of teamwork exhibited. The mission characterizations, characterized roles and personnel characterizations are provided to an optimization model 208, which may be run, for example, daily, along with production volumes 210 for the various missions, and in accordance with rules and algorithms 212 in a coupled database, for example, maximum working hours for each employee or any other constraints (for instance, in some area working overtime is not allowed). In one embodiment, the missions, roles and personnel characterizations may be periodically updated. For example, missions may be updated 214 monthly, while roles may be updated 216, e.g., yearly and personnel characterizations may be updated 218, e.g., quarterly.

In this invention, employee/resource allocations employed in a factory are considered as a pool of resources for all missions in an enterprise. Clustering is used to predict the suitability and performance of each employee to do any job based on the job requirements and the employee's personal preferences (e.g., willingness to move and/or learn another job), job title, and experience. A mathematical optimization model is used to assign resources to all jobs and ensuring meeting customer demand. Resource allocation is controlled by assigning the most appropriate resources characteristic to each job and the ultimate objective is meeting customer demand in addition to other constraints, such as, for example, ensuring all resources are allocated. This policy considers, for example, demand of each job type and employee personal features, experiences and training to estimate execution time for each job type to assign resources.

The model is a comprehensive, data-driven approach to evaluate different individual characteristics in order to build a complete profile about which jobs each employee can do and predict performance. The output of this model is resource assignment that ensures meeting customer demand.

The models used to forecast outcomes and staffing considers not only addressing immediate demands, but can also run in ‘training modes’ to build the right set of flexible skills that can be utilized more effectively in a strategic sense. However, in periods where channels peak simultaneously, the models would run tactically, to manage coverage and prescribe where to move resources to ensure all daily demands are met. The ultimate vision is that employees would receive text messages or have a dashboard that would advise them which area and what roles they would perform on a given day, rather than have managers wait for calls for help to redistribute resources across a factory. This is different than most workload forecasting tools because it uses much deeper and meaningful employee attributes, and it runs on a much more frequent cycle, responding to the strong variability between missions and within missions.

For the short term, besides assigning resources, the model encompasses measures to manage performance of the enterprise toward meeting customer demand and operational measures. Strategically, for future demand, the solution will help in defining the gap between forecasted demand and required performance and capacity and, accordingly, building a training plan to prepare the enterprise for future demand. Meeting demand is related to financial and customer satisfaction, while the assigning model is related to internal processes and the training plan is related to innovation and learning.

Disclosed is an employee/resource allocation system that will integrate with other systems to collect required data. The system comes with an intuitive user interface to make any changes such as resource availability and flexibility. The system includes the optimization model to assign resources, provide a summary for the management team to provide approval and, accordingly, send notifications to employees to know their work schedule.

In one example of an optimization model, it is assumed that each employee is assigned to one job type, there are no penalties associated with extra work and there is no overtime—working time is 8 hours per day and 32 hours per week.

The optimization model is given as:

max Σᵢ₌₁ⁿΣⱼ₌^{m}tᵢⱼpᵢⱼ

Wherein:

m: number of jobs

n: number of employees

pᵢⱼ: completed job j by employee i

tᵢⱼ: expected time to execute job j from employee i

dⱼ: demand of job j

i ∈ {1,2, . . . , n}

j ∈ {1, . . . , m}

w: working hours per day

Further, the optimization model is subject to the following constraints:

Σⱼ₌₁^{m}xᵢⱼ=1, ∀i

Σᵢ₌₁ⁿxᵢⱼ≥1, ∀j

Σⱼ₌₁^{m}pᵢⱼ×tᵢⱼ≤w, ∀l

Σᵢ₌₁pᵢⱼ≥dⱼ, ∀j

(pᵢⱼ×tᵢⱼ)/w≤xᵢⱼ, ∀ij

Pᵢⱼ is integer

$${x}_{ij} = \{ \begin{matrix}1 , if employee i is assigned to job j \\ 0 , if employee i isn ' t assigned to job j\end{matrix} \}$$

The constraints ensure that: each employee is assigned to one job only; at least one employee is assigned to each job; if possible, that each employee does not work more than number of working hours; a completed job from each job type meets or exceeds its demand; and that pᵢⱼ is forced to be zero if an employee is not assigned to a job j.

Table I below is one example of an employee matrix, with simple employee IDs along the first column, different job types (1-9) across the top row and a proficiency level (three levels of proficiency) for each employee at each job across the following rows. In one example, this type of matrix is used when historical data regarding performance is not available. If historical data is available, that will instead be used to gauge expected employee performance.

TABLE I

| | Task ID | | | | | | | | |
|---|---|---|---|---|---|---|---|---|---|
| Employee ID | 1 | 2 | 3 | 4 | 5 | 6 | 7 | 8 | 9 |
| E1 | 3 | 1 | 1 | 1 | 1 | 1 | 3 | 2 | 3 |
| E2 | 3 | 1 | 1 | 1 | 3 | 3 | 1 | 2 | 2 |
| E3 | 1 | 3 | 3 | 1 | 1 | 1 | 1 | 2 | 3 |
| E4 | 1 | 1 | 1 | 1 | 1 | 1 | 1 | 2 | 1 |
| E5 | 1 | 2 | 2 | 2 | 2 | 2 | 2 | 2 | 3 |
| E6 | 2 | 3 | 3 | 2 | 2 | 2 | 2 | 2 | 3 |
| E7 | 2 | 3 | 3 | 3 | 2 | 2 | 2 | 2 | 3 |
| E8 | 1 | 1 | 1 | 1 | 1 | 1 | 1 | 1 | 3 |
| E9 | 3 | 1 | 1 | 1 | 1 | 1 | 1 | 2 | 3 |
| E10 | 2 | 2 | 1 | 2 | 2 | 2 | 2 | 3 | 3 |
| E11 | 2 | 2 | 1 | 2 | 2 | 2 | 2 | 3 | 3 |
| E12 | 2 | 2 | 1 | 2 | 2 | 2 | 2 | 3 | 3 |
| E13 | 2 | 2 | 1 | 2 | 2 | 2 | 2 | 3 | 1 |

Table II shows an example of optimization model output for an employee assignment for the employees in Table I. A “1” indicates a job assignment and a “0” indicates no assignment for an employee to the corresponding job type. In addition, a column is added giving a predicted time for a given employee to perform each job assigned to that employee.

TABLE II

| | | | | | | | | | | Predicted |
|---|---|---|---|---|---|---|---|---|---|---|
| | Task ID | | | | | | | | | Utilization |
| Employee ID | 1 | 2 | 3 | 4 | 5 | 6 | 7 | 8 | 9 | Time |
| E1 | 1 | 1 | 0 | 0 | 0 | 0 | 0 | 0 | 0 | 27.8 |
| E2 | 0 | 1 | 0 | 0 | 0 | 0 | 0 | 0 | 0 | 31.86 |
| E3 | 0 | 0 | 0 | 0 | 1 | 0 | 0 | 0 | 0 | 16 |
| E4 | 0 | 0 | 0 | 0 | 0 | 0 | 0 | 0 | 0 | 0 |
| E5 | 1 | 0 | 0 | 0 | 0 | 0 | 0 | 0 | 0 | 16.8 |
| E6 | 0 | 0 | 0 | 0 | 0 | 0 | 0 | 0 | 0 | 0 |
| E6 | 0 | 0 | 0 | 0 | 0 | 0 | 0 | 0 | 1 | 10 |
| E7 | 0 | 0 | 0 | 0 | 0 | 0 | 0 | 0 | 0 | 0 |
| E8 | 0 | 0 | 0 | 1 | 0 | 0 | 0 | 0 | 0 | 15 |
| E9 | 1 | 0 | 0 | 0 | 0 | 0 | 0 | 0 | 0 | 16.8 |
| E10 | 0 | 1 | 0 | 0 | 1 | 0 | 0 | 0 | 0 | 31.54 |
| E11 | 0 | 0 | 1 | 0 | 0 | 0 | 1 | 0 | 0 | 24.6 |
| E12 | 0 | 0 | 0 | 0 | 0 | 1 | 0 | 0 | 0 | 26 |
| E13 | 0 | 0 | 0 | 0 | 0 | 0 | 0 | 1 | 0 | 16.8 |

Finally, Table III shows an example of another optimization model output for production by employee with added rows for an expected number of completed jobs per production cycle for each job an employee was assigned and the corresponding demand for that job type.

TABLE III

| | Task ID | | | | | | | | |
|---|---|---|---|---|---|---|---|---|---|
| Employee ID | 1 | 2 | 3 | 4 | 5 | 6 | 7 | 8 | 9 |
| E1 | 2 | 10 | 0 | 0 | 0 | 0 | 0 | 0 | 0 |
| E2 | 0 | 59 | 0 | 0 | 0 | 0 | 0 | 0 | 0 |
| E3 | 0 | 0 | 0 | 0 | 1 | 0 | 0 | 0 | 0 |
| E4 | 0 | 0 | 0 | 0 | 0 | 0 | 0 | 0 | 0 |
| E5 | 1 | 0 | 0 | 0 | 0 | 0 | 0 | 0 | 0 |
| E6 | 0 | 0 | 0 | 0 | 0 | 0 | 0 | 0 | 0 |
| E6 | 0 | 0 | 0 | 0 | 0 | 0 | 0 | 0 | 5 |
| E7 | 0 | 0 | 0 | 0 | 0 | 0 | 0 | 0 | 0 |
| E8 | 0 | 0 | 0 | 1 | 0 | 0 | 0 | 0 | 0 |
| E9 | 1 | 0 | 0 | 0 | 0 | 0 | 0 | 0 | 0 |
| E10 | 0 | 11 | 0 | 0 | 2 | 0 | 0 | 0 | 0 |
| E11 | 0 | 0 | 1 | 0 | 0 | 0 | 45 | 0 | 0 |
| E12 | 0 | 0 | 0 | 0 | 0 | 13 | 0 | 0 | 0 |
| E13 | 0 | 0 | 0 | 0 | 0 | 0 | 0 | 1 | 0 |
| Expected Number of | 4 | 80 | 1 | 1 | 3 | 13 | 45 | 1 | 5 |
| Completed Job | | | | | | | | | |
| Demand | 4 | 80 | 1 | 1 | 3 | 13 | 45 | 1 | 5 |

Aspects disclosed herein are applicable to any employee-intensive production environment, a smart employee allocation system; a systematic approach to align operational execution with strategic planning; being smoothly aligned with a balanced scorecard; and the use of data science to objectively model employee behavior, skill level and performance prediction.

In one embodiment, the implementing technology includes multisource data feed cloud application with publishing allocation to mobile or email or dashboard.

In various embodiments, real-time data is used to predict individual employee performance.

In one embodiment, necessary employee training is assessed based on evaluating the gap between current enterprise's skills and strategic skills requirements.

The approach disclosed herein considers employee behavior as part of the model input to define suitability for various jobs, as well as characterizes job requirements by including any required training and/or certificate.

Employee preferences are also considered as part of the optimization model inputs.

Employee willingness to take on a new job/task is also considered. What is considered “new” is based on similarity with other available job/task. Similarity is identified using data science approaches.

Employee performance and enterprise performance management system are aligned, with system integration of operations management, floor management, customer order management, demand forecasting (planning) systems.

Employees' job suitability is also considered using data science approaches to assess employee suitability based on their knowledge profile and job similarity, as explained herein.

Timespan can be short or long term depending on defined timespan. For example, weekly demand is short term. In training mode, the timespan can be long term because the system can build a training plan to build skills to meet one or more strategic production objectives.

Strategy roll out and operation management are smoothly aligned with strategy planning (build required skills that support production strategy); and support production planning based on facts to reduce execution uncertainty (related to employee, available skills and performance).

Operation management is aligned with strategic plan and enterprise performance management system (typically using balanced scorecard), which covers employee job assignment, training plan, and operation planning.

Disclosed herein is a new approach to allocation of resources, a cognitive approach using advanced analytics to transform different types of data, considers employee preferences (i.e., flexibility), knowledge and characteristics and provides a more objective approach to employee evaluation.

Disclosed is a dynamic approach, automating resource allocation with no time limit; it can be used to allocate resources daily or weekly or on monthly bases and requires limited changes (demand and resources' availability).

Certain embodiments herein may offer various technical computing advantages involving computing advantages to address problems arising in the realm of computer networks. Particularly, computing advantages related to a computer-implemented solution for employee/resource allocation across an enterprise. Embodiments herein include, for example, cognitively generating, by the data processing system, an optimization model performed iteratively to optimally assign employees to a plurality of job types, in order to achieve the aforementioned computing advantages. Embodiments herein include using the cognitively generated optimization model to optimally assign employees to job types across multiple production/manufacturing lines across the enterprise. Embodiments herein include an optimization model given by max Σᵢ₌₁ⁿΣⱼ₌₁^{m}tᵢⱼpᵢⱼ, wherein m: number of jobs; n: number of employees; pᵢⱼ: completed job j by employee i; tᵢⱼ: expected time to execute job j from employee i; dⱼ: demand of job j; i ∈ {1,2, . . . , n}; j ∈ {1, . . . , m}; w: working hours per day; and wherein the optimization model is subject to one or more constraint. Embodiments herein include cognitively predicting performance of a given employee for one or more job type. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g. processing for transforming unstructured data into a form optimized for computerized processing. Embodiments herein can examine data from diverse data sources such as data sources that process radio signals for location determination of users. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making.

In scenarios where text is to be cognitively interpreted, for example, an employee evaluation or a writing from an employee, Natural Language Understanding can be used.

The umbrella term “Natural Language Understanding” can be applied to a diverse set of computer applications, ranging from small, relatively simple tasks such as, for example, short commands issued to robots, to highly complex endeavors such as, for example, the full comprehension of newspaper articles or poetry passages. Many real world applications fall between the two extremes, for example, text classification for the automatic analysis of emails and their routing to a suitable department in a corporation does not require in-depth understanding of the text, but it does need to work with a much larger vocabulary and more diverse syntax than the management of simple queries to database tables with fixed schemata.

Regardless of the approach used, most natural language understanding systems share some common components. The system needs a lexicon of the language and a parser and grammar rules to break sentences into an internal representation. The construction of a rich lexicon with a suitable ontology requires significant effort, for example, the WORDNET lexicon required many person-years of effort. WORDNET is a large lexical database of English. Nouns, verbs, adjectives and adverbs are grouped into sets of cognitive synonyms (synsets), each expressing a distinct concept. Synsets are interlinked by means of conceptual-semantic and lexical relations. The resulting network of meaningfully related words and concepts can be navigated, for example, with a browser specially configured to provide the navigation functionality. WORDNET's structure makes it a useful tool for computational linguistics and natural language processing.

WORDNET superficially resembles a thesaurus, in that it groups words together based on their meanings. However, there are some important distinctions. First, WORDNET interlinks not just word forms—strings of letters—but specific senses of words. As a result, words that are found in close proximity to one another in the network are semantically disambiguated. Second, WORDNET labels the semantic relations among words, whereas the groupings of words in a thesaurus does not follow any explicit pattern other than meaning similarity.

The system also needs a semantic theory to guide the comprehension. The interpretation capabilities of a language understanding system depend on the semantic theory it uses. Competing semantic theories of language have specific trade-offs in their suitability as the basis of computer-automated semantic interpretation. These range from naive semantics or stochastic semantic analysis to the use of pragmatics to derive meaning from context.

Advanced applications of natural language understanding also attempt to incorporate logical inference within their framework. This is generally achieved by mapping the derived meaning into a set of assertions in predicate logic, then using logical deduction to arrive at conclusions. Therefore, systems based on functional languages such as the Lisp programming language need to include a subsystem to represent logical assertions, while logic-oriented systems such as those using the language Prolog, also a programming language, generally rely on an extension of the built-in logical representation framework.

A Natural Language Classifier, which could be a service, for example, applies cognitive computing techniques to return best matching predefined classes for short text inputs, such as a sentence or phrase. It has the ability to classify phrases that are expressed in natural language into categories. Natural Language Classifiers (“NLCs”) are based on Natural Language Understanding (NLU) technology (previously known as “Natural Language Processing”). NLU is a field of computer science, artificial intelligence (AI) and computational linguistics concerned with the interactions between computers and human (natural) languages.

For example, consider the following questions: “When can you meet me?” or When are you free?” or “Can you meet me at 2:00 PM?” or “Are you busy this afternoon?” NLC can determine that they are all ways of asking about “setting up an appointment.” Short phrases can be found in online discussion forums, emails, social media feeds, SMS messages, and electronic forms. Using, for example, IBM's Watson APIs (Application Programming Interface), one can send text from these sources to a natural language classifier trained using machine learning techniques. The classifier will return its prediction of a class that best captures what is being expressed in that text. Based on the predicted class one can trigger an application to take the appropriate action such as providing an answer to a question, suggest a relevant product based on expressed interest or forward the text to an appropriate human expert who can help.

Applications of such APIs include, for example, classifying email as SPAM or No-SPAM based on the subject line and email body; creating question and answer (Q&A) applications for a particular industry or domain; classifying news content following some specific classification such as business, entertainment, politics, sports, and so on; categorizing volumes of written content; categorizing music albums following some criteria such as genre, singer, and so on; and classifying frequently asked questions (FAQs).

In general, the term “cognitive computing” (CC) has been used to refer to new hardware and/or software that mimics the functioning of the human brain and helps to improve human decision-making, which can be further improved using machine learning. In this sense, CC is a new type of computing with the goal of more accurate models of how the human brain/mind senses, reasons, and responds to stimulus. CC applications link data analysis and adaptive page displays (AUI) to adjust content for a particular type of audience. As such, CC hardware and applications strive to be more effective and more influential by design.

Some common features that cognitive systems may express include, for example: ADAPTIVE—they may learn as information changes, and as goals and requirements evolve. They may resolve ambiguity and tolerate unpredictability. They may be engineered to feed on dynamic data in real time, or near real time; INTERACTIVE—they may interact easily with users so that those users can define their needs comfortably. They may also interact with other processors, devices, and Cloud services, as well as with people; ITERATIVE AND STATEFUL—they may aid in defining a problem by asking questions or finding additional source input if a problem statement is ambiguous or incomplete. They may “remember” previous interactions in a process and return information that is suitable for the specific application at that point in time; and CONTEXTUAL—they may understand, identify, and extract contextual elements such as meaning, syntax, time, location, appropriate domain, regulations, user's profile, process, task and goal. They may draw on multiple sources of information, including both structured and unstructured digital information, as well as sensory inputs (e.g., visual, gestural, auditory and/or sensor-provided).

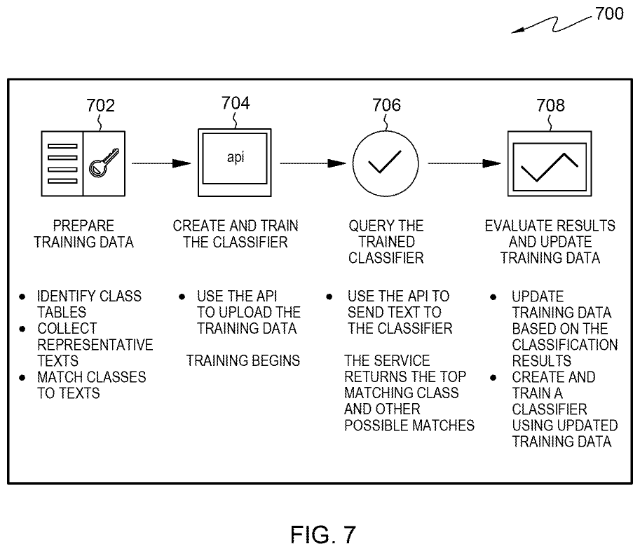

FIG. 7 is a hybrid flow diagram 700 of one example of an overview of the basic steps for creating and using a natural language classifier service. Initially, training data for machine learning is prepared, 702, by identifying class tables, collecting representative texts and matching the classes to the representative texts. An API (Application Planning Interface) may then be used to create and train the classifier 704 by, for example, using the API to upload training data. Training may begin at this point. After training, queries can be made to the trained natural language classifier, 706. For example, the API may be used to send text to the classifier. The classifier service then returns the matching class, along with other possible matches. The results may then be evaluated and the training data updated, 708, for example, by updating the training data based on the classification results. Another classifier can then be trained using the updated training data.

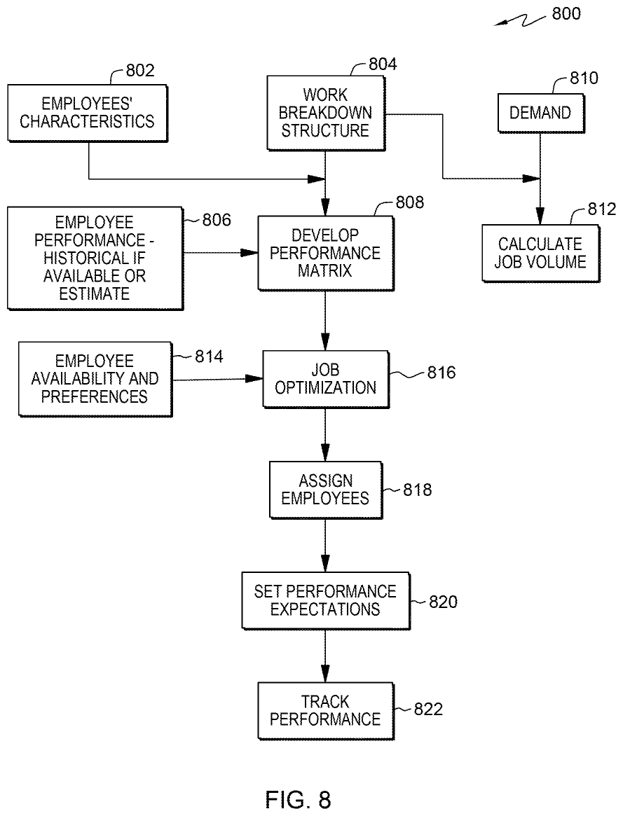

FIG. 8 is a flow diagram 800 for one example of employee/resource allocation in a manufacturing environment, in accordance with one or more aspects of the present disclosure. Employee characteristics 802 (e.g., experience, academic qualifications, certificates, degrees, etc.), aptitude, teamwork, special needs accommodations, etc.), a work breakdown structure 804 and employee performance 806 (historical if available or estimated) are all used to develop a performance matrix 808. The work breakdown structure and customer demand are used to calculate a job volume 812. The calculated job volume, employee availability and preferences 814 and the performance matrix are used for job optimization 816, which is used to assign jobs to employees 818 and set performance expectations 820. Actual performance is then tracked 822 for each employee assigned a job.

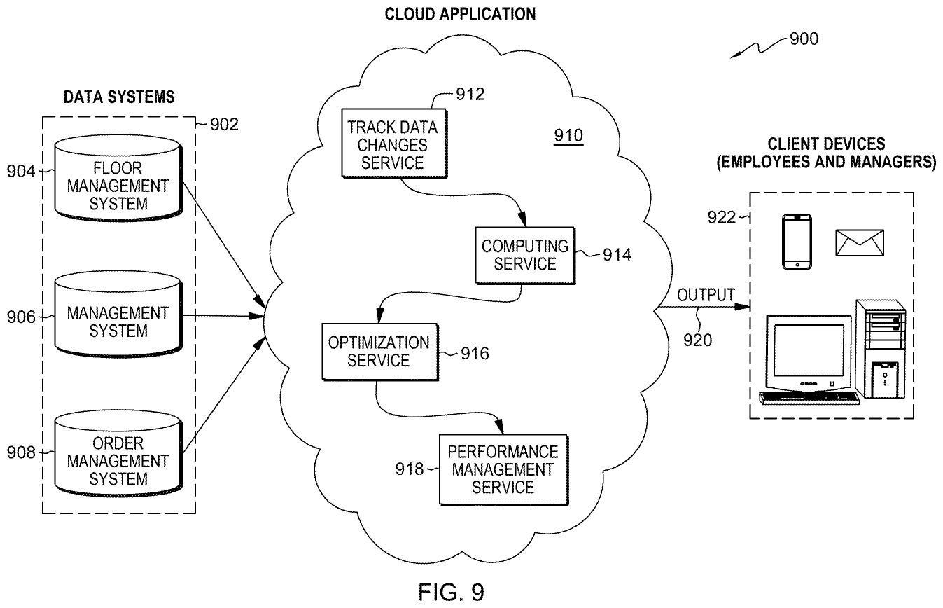

FIG. 9 is a block diagram of one example of a system 900 for employee/resource allocation across an enterprise in a manufacturing environment, in accordance with one or more aspects of the present disclosure. Data systems 902 include, for example, a floor management system 904, a management system 906 and an order management system 908. The data systems are fed to a remote computing resource (or “cloud”) application 910. The application may provide, for example, one or more of a data change tracking service 912, a computing service 914, an optimization service 916 and a performance management service 918 to implement and track the employee/resource allocation described herein. Output 920 of the application is routed to client devices 922, for example, the employees and managers of the enterprise.

Various decision data structures can be used to drive artificial intelligence (AI) decision making, such as decision data structure that cognitively maps social media interactions in relation to posted content in respect to parameters for use in better allocations that can include allocations of digital rights. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms.

In addition, providing the cognitive recommendations may include searching cross co-occurrence matrices in making the cognitive recommendations. Based, at least in part, on the user behaviors and the items interacted with, a subsequent behavior of the user is predicted in real-time during the visit. The prediction may be made employing a predictive model trained using machine learning. The cognitive recommendations correspond to items not yet interacted with by the user and are provided to the user in real-time based, at least in part, on the predicted behavior of the user and the items interacted with by the user. The cognitive recommendations may be continually or periodically updated during the user's visit to the venue. The monitoring, predicting and providing the cognitive recommendations are performed by a processor, in communication with a memory storing instructions for the processor to carry out the monitoring, predicting and providing of cognitive recommendations to the user.

Various decision data structures can be used to drive artificial intelligence (AI) decision making, such as decision data structure that cognitively maps social media interactions in relation to posted content in respect to parameters for use in better allocations that can include allocations of digital rights. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead.

For enhancement of computational accuracies, embodiments can feature computational platforms existing only in the realm of computer networks such as artificial intelligence platforms, and machine learning platforms. Embodiments herein can employ data structuring processes, e.g. processing for transforming unstructured data into a form optimized for computerized processing. Embodiments herein can examine data from diverse data sources such as data sources that process radio or other signals for location determination of users. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience.

Where used herein, the term “real-time” refers to a period of time necessary for data processing and presentation to a user to take place, and which is fast enough that a user does not perceive any significant delay. Thus, “real-time” is from the perspective of the user.

In one example, the system employs a machine learning process that can update one or more process run by the system based on obtained data to improve accuracy and/or reliability of the one or more process. In one example, the system may, for example, use a decision data structure that predicts, in accordance with a predicting process, employee performance.

The system herein, in one example, can run a plurality of instances of such a decision data structure, each instance for a different employee. For each instance of the decision data structure, the system can change any applicable variables. Such a system running a machine learning process can continually or periodically update the variables of the different instances of the decision data structure.

The system can run various preparation and maintenance processes to populate and maintain data of a data repository or database for use by various processes within the system, including e.g., the predicting process.

In addition, the system can run a Natural Language Understanding (NLU) process for determining one or more NLU output parameter of text. Such a NLU process can include one or more of a topic classification process that determines topics and outputs one or more topic NLU output parameter, a sentiment analysis process which determines sentiment parameter for text where applicable, e.g., polar sentiment NLU output parameters, “negative,” “positive,” and/or non-polar NLU output sentiment parameters, e.g., “anger,” “disgust,” “fear,” “joy,” and/or “sadness” or other classification process for output of one or more other NLU output parameters, e.g., one of more “social tendency” NLU output parameter or one or more “writing style” NLU output parameter.

The disclosure is directed to an employee/resource allocation system utilizing an optimization model to assign resources. The method includes: receiving a workload matrix, the workload matrix including job types and a level of demand for each job type; receiving an employee matrix, the employee matrix including employees and data associated with each of the employees, the data associated with each of the plurality of employees includes experience, schedule availability, academic qualifications, and a set of personal traits; generating a skills matrix based on the data associated with each of the employees; responsive to performing an iteration of an optimization model, assigning the employees to the job types based on the iteration; and sending an assignment of a first job type to a first employee based on the assigning of the employees to the job types.

In a first aspect, disclosed above is a computer-implemented method of employee/resource allocation across an enterprise, the computer-implemented method includes: receiving, by a data processing system, a workload matrix, the workload matrix including job types and a level of demand for each job type; receiving, by the data processing system, an employee matrix, wherein the employee matrix comprises a plurality of employees; generating, by the data processing system, a skills matrix for the enterprise based on the characteristics associated with each of the employees; generating, by the data processing system, a performance matrix for the plurality of employees, the performance matrix comprising a plurality of characteristics associated with the plurality of employees and employee performance information; cognitively generating, by the data processing system, an optimization model from the workload matrix, the employee matrix, the skills matrix and the performance matrix; responsive to performing an iteration of the optimization model, assigning, by the data processing system, the employees to the job types based on the iteration, resulting in a report; and implementing the report in the enterprise.

In one example, the implementing may include, for example, communicating to at least one of an employee and a manager an assignment of a first job type to a first employee based on the assigning of the employees to the job types.

In one example, the data processing system in the computer-implemented method of the first aspect may be, for example, operable in a training operation mode and an employee allocation operation mode.

In one example, the enterprise in the computer-implemented method of the first aspect may have, for example, at least two manufacturing lines and the report covers each of the job types for the at least two manufacturing lines.

In one example, the optimization model in the computer-implemented method of the first aspect may include, for example: max Σᵢ₌₁ⁿΣⱼ₌₁^{m}tᵢⱼpᵢⱼ, wherein m: number of jobs; n: number of employees; pᵢⱼ: completed job j by employee i; tᵢⱼ: expected time to execute job j from employee i; dⱼ: demand of job j; i ∈ {1,2, . . . , n}; j ∈ {1, . . . , m;}w: working hours per day; and wherein the optimization model is subject to one or more constraint. In one example, the constraint(s) may include, for example: each employee of the plurality of employees is assigned to only one job; each job has assigned employee(s); each employee of the works no more than a predetermined number of working hours; each completed job from each job type meets or exceeds the level of demand; for each employee not assigned to a job, forcing a completed number of jobs to be zero; and for each employee assigned to a job, a completed number of jobs is a positive integer. In one example, for at least one employee, a number of hours worked is different than the predetermined number of working hours.

In one example, the computer-implemented method of the first aspect may further include, for example, prior to the assigning, cognitively predicting employee performance at each of the job types for each of the employees, resulting in cognitively predicted performances, the optimization model using the cognitively predicted performances in the assigning.

In one example, the characteristics associated with each of the employees may include, for example, training, experience, schedule availability, academic qualifications, and a set of personal characteristics.

In one example, the computer-implemented method of the first aspect may further include, for example, after the assigning, building a training plan for the enterprise.

In a second aspect, disclosed above is a system for recommending actions for employee/resource allocation across an enterprise, the system including a memory; and processor(s) in communication with the memory to perform a method, the method including: receiving, by a data processing system, a workload matrix, the workload matrix including job types and a level of demand for each job type; receiving, by the data processing system, an employee matrix, wherein the employee matrix comprises a plurality of employees; generating, by the data processing system, a skills matrix for the enterprise based on the characteristics associated with each of the employees; generating, by the data processing system, a performance matrix for the plurality of employees, the performance matrix comprising a plurality of characteristics associated with the plurality of employees and employee performance information; cognitively generating, by the data processing system, an optimization model from the workload matrix, the employee matrix, the skills matrix and the performance matrix; responsive to performing an iteration of the optimization model, assigning, by the data processing system, the employees to the job types based on the iteration, resulting in a report; and implementing the report in the enterprise.

In one example, the enterprise may have, for example, at least two manufacturing lines and the report covers each of the job types for the at least two manufacturing lines.

In one example, the optimization model in the system of the second aspect may include, for example: max Σᵢ₌₁ⁿΣⱼ₌₁^{m}tᵢⱼpᵢⱼ, wherein m: number of jobs; n: number of employees; pᵢⱼ: completed job j by employee i; tᵢⱼ: expected time to execute job j from employee i; dⱼ: demand of job j; i ∈ {1, 2, . . . , n}; j ∈ {1, . . . , m}; w: working hours per day; and prior to the assigning, cognitively predicting employee performance at each of the job types for each of the employees, resulting in cognitively predicted performances, the optimization model using the cognitively predicted performances in the assigning.

In one example, the characteristics associated with each of the employees in the system of the second aspect may include, for example, training, experience, schedule availability, academic qualifications, and a set of personal characteristics.

In a third aspect, disclosed above is a computer program product for employee/resource allocation across an enterprise, the computer program product includes: a medium readable by a processor and storing instructions for performing a method of sending notifications, the method including: receiving, by a data processing system, a workload matrix, the workload matrix including job types and a level of demand for each job type; receiving, by the data processing system, an employee matrix, wherein the employee matrix comprises a plurality of employees; generating, by the data processing system, a skills matrix for the enterprise based on the characteristics associated with each of the employees; generating, by the data processing system, a performance matrix for the plurality of employees, the performance matrix comprising a plurality of characteristics associated with the plurality of employees and employee performance information; cognitively generating, by the data processing system, an optimization model from the workload matrix, the employee matrix, the skills matrix and the performance matrix; responsive to performing an iteration of the optimization model, assigning, by the data processing system, the employees to the job types based on the iteration, resulting in a report; and implementing the report in the enterprise.

In one example, the enterprise may have, for example, at least two manufacturing lines and the report covers each of the job types for the at least two manufacturing lines.

In one example, the optimization model in the method of the computer program product of the third aspect may include, for example: max Σᵢ₌₁ⁿΣⱼ₌₁^{m}tᵢⱼpᵢⱼ, wherein m: number of jobs; n: number of employees; pᵢⱼ: completed job j by employee i; tᵢⱼ: expected time to execute job j from employee i; dⱼ: demand of job j; i ∈ {1,2, . . . , n}; j ∈ {1, . . . , m}; w: working hours per day; and prior to the assigning, cognitively predicting employee performance at each of the job types for each of the employees, resulting in cognitively predicted performances, the optimization model using the cognitively predicted performances in the assigning.

In one example, the characteristics associated with each of the employees in the method of the computer program product of the third aspect may include, for example, training, experience, schedule availability, academic qualifications, and a set of personal characteristics.

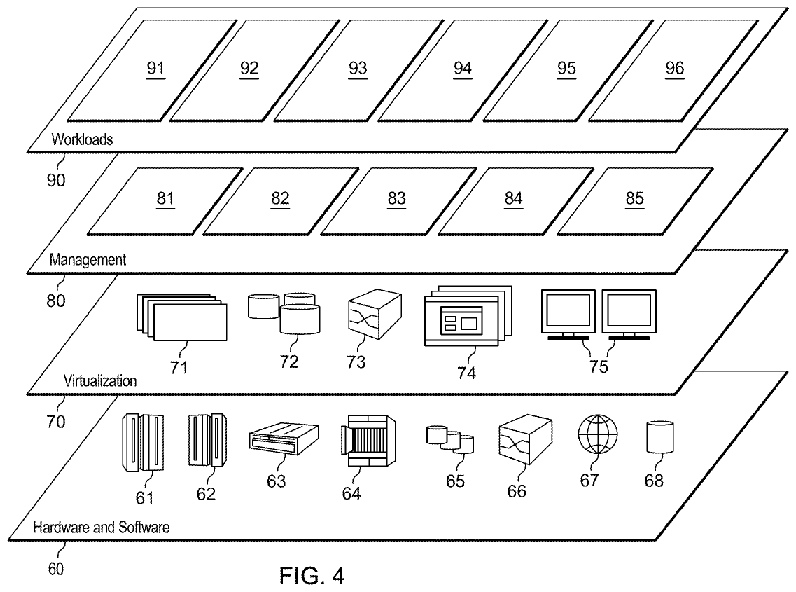

FIGS. 4-6 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, a schematic of an example of a computing node is shown. Computing node 10 is only one example of a computing node suitable for use as a cloud computing node and is not intended to suggest any limitation as to the scope of use or functionality of embodiments of the invention described herein. Regardless, computing node 10 is capable of being implemented and/or performing any of the functionality set forth hereinabove. Computing node 10 can be implemented as a cloud computing node in a cloud computing environment, or can be implemented as a computing node in a computing environment other than a cloud computing environment.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

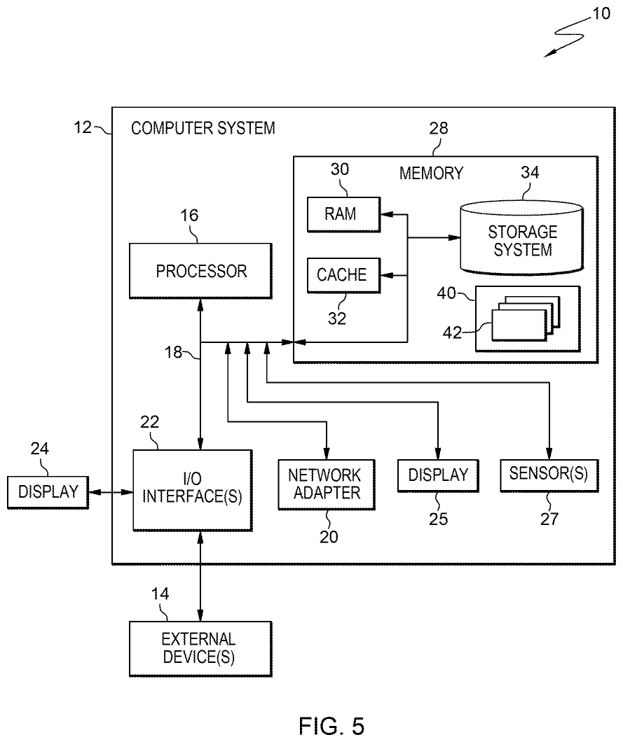

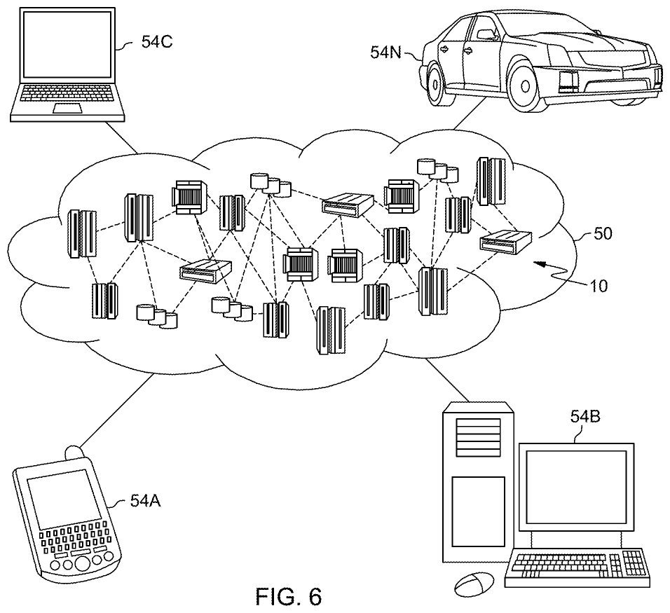

As shown in FIG. 4, computer system 12 in computing node 10 is shown in the form of a computing device. The components of computer system 12 may include, but are not limited to, one or more processor 16, a system memory 28, and a bus 18 that couples various system components including system memory 28 to processor 16. In one embodiment, computing node 10 is a computing node of a non-cloud computing environment. In one embodiment, computing node 10 is a computing node of a cloud computing environment as set forth herein in connection with FIGS. 5-6.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. One or more program 40 including program processes 42 can generally carry out the functions set forth herein. One or more program 40 including program processes 42 can define machine logic to carry out the functions set forth herein. In one embodiment, the system can include one or more computing node 10 and can include one or more program 40 for performing functions described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display 24, which can be configured to provide user interface functionality, computing node 10 in one embodiment can include display 25 connected to bus 18. In one embodiment, display 25 can be configured as a touch screen display and can be configured to provide user interface functionality, e.g. can facilitate virtual keyboard functionality and input of total data. Computer system 12 in one embodiment can also include one or more sensor device 27 connected to bus 18. One or more sensor device 27 can alternatively be connected through I/O interface(s) 22. One or more sensor device 27 can include a Global Positioning Sensor (GPS) device in one embodiment and can be configured to provide a location of computing node 10. In one embodiment, one or more sensor device 27 can alternatively or in addition include, e.g., one or more of a camera, a gyroscope, a temperature sensor, a humidity sensor, a pulse sensor, a blood pressure (bp) sensor or an audio input device. Computer system 12 can include one or more network adapter 20. In FIG. 5 computing node 10 is described as being implemented in a cloud computing environment and accordingly is referred to as a cloud computing node in the context of FIG. 5.

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for establishing and updating geofence locations as set forth herein. The processing components 96 can be implemented with use of one or more program 40 described in FIG. 4.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer-implemented method of employee/resource allocation across an enterprise, the computer-implemented method comprising:
receiving, by a data processing system, a workload matrix, wherein the workload matrix comprises a plurality of job types and a level of demand for each job type;
receiving, by the data processing system, an employee matrix, wherein the employee matrix comprises a plurality of employees;
generating, by the data processing system, a skills matrix for the enterprise based on the plurality of characteristics associated with each of the plurality of employees;
generating, by the data processing system, a performance matrix for the plurality of employees, the performance matrix comprising a plurality of characteristics associated with the plurality of employees and employee performance information;
cognitively generating, by the data processing system, an optimization model from the workload matrix, the employee matrix, the skills matrix and the performance matrix;
responsive to performing an iteration of the optimization model, assigning, by the data processing system, the plurality of employees to the plurality of job types based on the iteration, resulting in a report; and
implementing the report in the enterprise.

2. The computer-implemented method of claim 1, wherein the implementing comprises communicating to at least one of an employee and a manager an assignment of a first job type to a first employee based on the assigning of the plurality of employees to the plurality of job types.

3. The computer-implemented method of claim 1, wherein the data processing system is operable in a training operation mode and an employee allocation operation mode.

4. The computer-implemented method of claim 1, wherein the enterprise has at least two manufacturing lines and wherein the report covers each of the plurality of job types for the at least two manufacturing lines.

5. The computer-implemented method of claim 1, wherein the optimization model comprises: max Σᵢ₌₁ⁿΣⱼ₌₁^{m}tᵢⱼpᵢⱼ, wherein m: number of jobs; n: number of employees; pᵢⱼ: completed job j by employee i; tᵢⱼ: expected time to execute job j from employee i; dⱼ: demand of job j; i ∈ {1,2, . . . , n}; j ∈ {1, . . . , m}; w: working hours per day; and wherein the optimization model is subject to one or more constraint.

6. The computer-implemented method of claim 5, wherein the one or more constraint comprises: each employee of the plurality of employees is assigned to only one job; each job has at least one assigned employee; each employee of the plurality of employees works no more than a predetermined number of working hours; each completed job from each job type meets or exceeds the level of demand; for each employee not assigned to a job, forcing a completed number of jobs to be zero; and for each employee assigned to a job, a completed number of jobs is a positive integer.

7. The computer-implemented method of claim 6, wherein, for at least one employee of the plurality of employees, a number of hours worked is different than the predetermined number of working hours.

8. The computer-implemented method of claim 1, further comprising, prior to the assigning, cognitively predicting employee performance at each of the plurality of job types for each of the plurality of employees, resulting in a plurality of cognitively predicted performances, wherein the optimization model uses the plurality of cognitively predicted performances in the assigning.

9. The computer-implemented method of claim 1, wherein the plurality of characteristics associated with each of the plurality of employees comprises training, experience, schedule availability, academic qualifications, and a set of personal characteristics.

10. The computer-implemented method of claim 1, further comprising, after the assigning, building a training plan for the enterprise.

11. A system for recommending actions for employee/resource allocation across an enterprise, the system comprising:
a memory; and
at least one processor in communication with the memory to perform a method, the method comprising:
receiving, by a data processing system, a workload matrix, wherein the workload matrix comprises a plurality of job types and a level of demand for each job type;
receiving, by the data processing system, an employee matrix, wherein the employee matrix comprises a plurality of employees;
generating, by the data processing system, a skills matrix for the enterprise based on the plurality of characteristics associated with each of the plurality of employees;
generating, by the data processing system, a performance matrix for the plurality of employees, the performance matrix comprising a plurality of characteristics associated with the plurality of employees and employee performance information;
cognitively generating, by the data processing system, an optimization model from the workload matrix, the employee matrix, the skills matrix and the performance matrix;
responsive to performing an iteration of the optimization model, assigning, by the data processing system, the plurality of employees to the plurality of job types based on the iteration, resulting in a report; and
implementing the report in the enterprise.

12. The system of claim 11, wherein the enterprise has at least two manufacturing lines and wherein the report covers each of the plurality of job types for the at least two manufacturing lines.

13. The system of claim 11, wherein the optimization model comprises:
max Σᵢ₌₁ⁿΣⱼ₌₁^{m}tᵢⱼpᵢⱼ, wherein m: number of jobs; n: number of employees; pᵢⱼ: completed job j by employee i; tᵢⱼ: expected time to execute job j from employee i; dⱼ: demand of job j;
i ∈ {1,2, . . . , n}; j ∈ {1, . . . , m}; w: working hours per day; and wherein the optimization model is subject to one or more constraint.

14. The system of claim 13, further comprising, prior to the assigning, cognitively predicting employee performance at each of the plurality of job types for each of the plurality of employees, resulting in a plurality of cognitively predicted performances, wherein the optimization model uses the plurality of cognitively predicted performances in the assigning.

15. The system of claim 11, wherein the plurality of characteristics associated with each of the plurality of employees comprises training, experience, schedule availability, academic qualifications, and a set of personal characteristics.

16. A computer program product for employee/resource allocation across an enterprise, the computer program product comprising:
a medium readable by a processor and storing instructions for performing a method of sending notifications, the method comprising:
receiving, by a data processing system, a workload matrix, wherein the workload matrix comprises a plurality of job types and a level of demand for each job type;
receiving, by the data processing system, an employee matrix, wherein the employee matrix comprises a plurality of employees;
generating, by the data processing system, a skills matrix for the enterprise based on the plurality of characteristics associated with each of the plurality of employees;
generating, by the data processing system, a performance matrix for the plurality of employees, the performance matrix comprising a plurality of characteristics associated with the plurality of employees and employee performance information;
cognitively generating, by the data processing system, an optimization model from the workload matrix, the employee matrix, the skills matrix and the performance matrix;
responsive to performing an iteration of the optimization model, assigning, by the data processing system, the plurality of employees to the plurality of job types based on the iteration, resulting in a report; and
implementing the report in the enterprise.

17. The computer program product of claim 16, wherein the enterprise has at least two manufacturing lines and wherein the report covers each of the plurality of job types for the at least two manufacturing lines.

18. The computer program product of claim 16, wherein the optimization model comprises:
max Σᵢ₌₁ⁿΣⱼ₌₁^{m}tᵢⱼpᵢⱼ, wherein m: number of jobs; n: number of employees; pᵢⱼ: completed job j by employee i; tᵢⱼ: expected time to execute job j from employee i; dⱼ: demand of job j;
i ∈ {1,2, . . . , n}; j ∈ {1, . . . , m}; w: working hours per day; and wherein the optimization model is subject to one or more constraint.

19. The computer program product of claim 18, further comprising, prior to the assigning, cognitively predicting employee performance at each of the plurality of job types for each of the plurality of employees, resulting in a plurality of cognitively predicted performances, wherein the optimization model uses the plurality of cognitively predicted performances in the assigning.

20. The computer program product of claim 16, wherein the plurality of characteristics associated with each of the plurality of employees comprises training, experience, schedule availability, academic qualifications, and a set of personal characteristics.
